(19) United States
(12) Patent Application Publication
(10) Pub. No.: US 2026/0178585 A1
(43) Pub. Date: Jun. 25, 2026

(54) SYSTEM AND METHOD FOR QUERYING AN ENTERPRISE ARTIFICIAL INTELLIGENCE SYSTEM

(71) Applicant: MOTOROLA SOLUTIONS, INC., CHICAGO, IL (US)

(72) Inventors: WOOI PING TEOH, TANJUNG TOKONG (MY); ANOOP SEHGAL PARAS RAM, IPOH (MY); CHUN WEN OOI, GEORGETOWN (MY); TEJEASH DURAIMANICKAM, LUNAS (MY); MARIYA BONDAREVA, LOXAHATCHEE, FL (US)

(21) Appl. No.: 18/991,773

(22) Filed: Dec. 23, 2024

(51) Int. Cl. G06F 16/2453; G06Q 50/26

(52) U.S. Cl. CPC G06F 16/24549; G06Q 50/265

(57) ABSTRACT

Systems and methods for querying an enterprise artificial intelligence system based on a context from a public safety artificial intelligence system are provided. A query to the public safety artificial intelligence system is received from a public safety user. It is determined that input from the enterprise artificial intelligence system is needed to respond to the query. Based on the query, it is determined that the query includes public safety specific context that will not be correctly understood by the enterprise artificial intelligence. The query is transformed, based on the context, to an optimized query, wherein the optimized query will be correctly understood by the enterprise artificial intelligence. The optimized query is sent to the enterprise artificial intelligence system. A response to the optimized query is received from the enterprise artificial intelligence system.

### BACKGROUND

Artificial intelligence systems have become more and more available and sophisticated. In particular, advances in Large Language Models (LLM) have allowed for the creation of virtual assistants that can be used in different contexts. For example, a retail environment may create a virtual assistant based on a LLM trained with information associated with the context of the retail environment. Users within the retail environment may present questions to the virtual assistant that will then respond with answers relevant to the retail context. For example, a user may ask, “Where can I find Blue Polo shirts?” and the retail virtual assistant may respond with the location where that type of item may be found.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is an example of an interaction between a Public Safety Artificial Intelligence and an Enterprise Artificial Intelligence.

FIG. 2 is another example of an interaction between a Public Safety Artificial Intelligence and an Enterprise Artificial Intelligence.

FIG. 3 is an example of the use of agentic workflows to enable the interaction between a Public Safety Artificial Intelligence and an Enterprise Artificial Intelligence.

FIG. 4 is an example of a flow diagram that implements the querying an enterprise artificial intelligence system techniques described herein.

FIG. 5 is an example of a hardware device that implements the querying an enterprise artificial intelligence system techniques described herein.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

Virtual assistants can be trained based on domain specific datasets. In the example above, the retail virtual assistant may have been trained with data related to a retail environment. As such, the retail virtual assistant is well suited to answer questions in the context of a retail environment. Other such domains may also exist (e.g. office environment, etc.). For purposes of this description, virtual assistants trained in a civilian environment will be referred to interchangeably as enterprise artificial intelligence systems or enterprise virtual assistants.

There may also be virtual assistants trained in the domain of public safety responders (e.g. police, fire, emergency medical services, etc.). These virtual assistants may be interchangeably referred to as public safety artificial intelligence systems or public safety virtual assistants. As should be clear, public safety artificial intelligence systems are suited to answer questions in the context of public safety.

In some cases, a query to a virtual assistant in one domain (e.g. public safety virtual assistant) could benefit from input provided by a virtual assistant in a different domain (e.g. an enterprise virtual assistant). For example, a police officer may query a public safety virtual assistant to determine where a robbery suspect was last seen inside a shopping mall. The public safety system may not have access to surveillance resources of the shopping mall. An enterprise virtual assistant associated with the shopping mall has access to the surveillance resources and would be better able to respond to the query than the public safety virtual assistant.

Although the initial query could be simply sent to the enterprise virtual assistant, several problems exist with such an approach. One problem is that since each virtual assistant is trained with data from its own domain. For example, querying for a suspect in a public safety context makes sense while an enterprise virtual assistant may not understand what a suspect is, because “suspect” is not terminology normally used in an enterprise (e.g. civilian, etc.) environment. As yet another example, an enterprise virtual assistant may bias answers towards the enterprise domain as opposed to providing answers relevant to the public safety context. In general, the problem is that the enterprise virtual assistant is not trained with public safety data, and as such may not be able to effectively respond to queries coming from a public safety user.

The techniques described herein overcome these problems, individually and collectively. A query to a public safety artificial intelligence is received from a public safety user. The query is analyzed to determine if an answer from an enterprise artificial intelligence system is needed to provide a correct answer. For example, the enterprise artificial intelligence system has been trained/has access to resources not available to the public safety artificial intelligence system.

If input from the enterprise artificial intelligence system is needed, the query is further analyzed to determine if the query includes public safety specific context that will not be correctly understood by the enterprise artificial intelligence system. Using an agentic workflow, the query is transformed to an optimized query. The optimized query replaces those elements of the query that will not be understood by the enterprise artificial intelligence system with elements that will be understood.

The optimized query is then sent to the enterprise artificial intelligence system. Because the optimized query does not include elements that the enterprise artificial intelligence system does not understand, the enterprise artificial intelligence system can generate a correct answer/response to the query. This correct answer/response is then returned to the public safety query initiator.

A method of querying an enterprise artificial intelligence system based on a context from a public safety artificial intelligence system is provided. The method includes receiving, from a public safety user, a query to the public safety artificial intelligence system. The method also includes determining that input from the enterprise artificial intelligence system is needed to respond to the query. The method also includes determining, based on the query, that the query includes public safety specific context that will not be correctly understood by the enterprise artificial intelligence. The method also includes transforming the query, based on the context, to an optimized query, wherein the optimized query will be correctly understood by the enterprise artificial intelligence. The method also includes sending the optimized query to the enterprise artificial intelligence system. The method also includes receiving a response to the optimized query from the enterprise artificial intelligence system.

In one aspect of the method, transforming the query further comprises identifying a set of tools available in the enterprise artificial intelligence system, selecting a subset of the available tools in the enterprise artificial intelligence system to transform the query based on the public safety specific context, and executing the selected subset of tools to create the optimized query.

In one aspect of the method, a tool of the set of tools further comprises retrieving, based on the public safety specific context, data relevant to a context associated with the enterprise artificial intelligence. In one aspect of the method, a tool of the set of tools further comprises determining a portion of the query has a public safety specific context, identifying a query that corresponds to the portion of the query in a context associated with the enterprise artificial intelligence, and substituting the portion of the query with the identified query. In one aspect of the method, the portion of the query is a request to establish a perimeter and the identified query is a request to set up a workflow with a tripwire analytic.

In one aspect of the method, a tool of the set of tools further comprises retrieving a chat history of a source of the query. In one aspect of the method, a tool of the set of tools further comprises executing a video analytic on a video associated with the query.

A system for querying an enterprise artificial intelligence system based on a context from a public safety artificial intelligence system is provided. The system comprises a processor and a memory coupled to the processor. The memory contains a set of instructions thereon that when executed by the processor cause the processor to receive, from a public safety user, a query to the public safety artificial intelligence system. The instructions on the memory also cause the processor to determine that input from the enterprise artificial intelligence system is needed to respond to the query. The instructions on the memory also cause the processor to determine, based on the query, that the query includes public safety specific context that will not be correctly understood by the enterprise artificial intelligence. The instructions on the memory also cause the processor to transform the query, based on the context, to an optimized query, wherein the optimized query will be correctly understood by the enterprise artificial intelligence. The instructions on the memory also cause the processor to send the optimized query to the enterprise artificial intelligence system. The instructions on the memory also cause the processor to receive a response to the optimized query from the enterprise artificial intelligence system.

In one aspect of the system, transforming the query further comprises instructions on the memory that cause the processor to identify a set of tools available in the enterprise artificial intelligence system, select a subset of the available tools in the enterprise artificial intelligence system to transform the query based on the public safety specific context, and execute the selected subset of tools to create the optimized query.

In one aspect of the system, a tool of the set of tools further comprises instructions on the memory that cause the processor to retrieve, based on the public safety specific context, data relevant to a context associated with the enterprise artificial intelligence. In one aspect of the system, a tool of the set of tools further comprises instructions on the memory that cause the processor to determine a portion of the query has a public safety specific context, identify a query that corresponds to the portion of the query in a context associated with the enterprise artificial intelligence, and substitute the portion of the query with the identified query. In one aspect of the system the portion of the query is a request to establish a perimeter and the identified query is a request to set up a workflow with a tripwire analytic.

In one aspect of the system, a tool of the set of tools further comprises instructions on the memory that cause the processor to retrieve a chat history of a source of the query. In one aspect of the system, a tool of the set of tools further comprises instructions on the memory that cause the processor to execute a video analytic on a video associated with the query.

A non-transitory processor readable medium containing a set of instructions thereon for querying an enterprise artificial intelligence system based on a context from a public safety artificial intelligence system is provided. The instructions, that when executed by a processor, cause the processor to receive, from a public safety user, a query to the public safety artificial intelligence system. The instructions on the medium also cause the processor to determine that input from the enterprise artificial intelligence system is needed to respond to the query. The instructions on the medium also cause the processor to determine, based on the query, that the query includes public safety specific context that will not be correctly understood by the enterprise artificial intelligence. The instructions on the medium also cause the processor to transform the query, based on the context, to an optimized query, wherein the optimized query will be correctly understood by the enterprise artificial intelligence. The instructions on the medium also cause the processor to send the optimized query to the enterprise artificial intelligence system. The instructions on the medium also cause the processor to receive a response to the optimized query from the enterprise artificial intelligence system.

In one aspect of the medium, transforming the query further comprises instructions on the medium that cause the processor to identify a set of tools available in the enterprise artificial intelligence system, select a subset of the available tools in the enterprise artificial intelligence system to transform the query based on the public safety specific context, and execute the selected subset of tools to create the optimized query.

In one aspect of the medium, a tool of the set of tools further comprises instructions on the medium that cause the processor to retrieve, based on the public safety specific context, data relevant to a context associated with the enterprise artificial intelligence. In one aspect of the medium, a tool of the set of tools further comprises instructions on the medium that cause the processor to determine a portion of the query has a public safety specific context, identify a query that corresponds to the portion of the query in a context associated with the enterprise artificial intelligence, and substitute the portion of the query with the identified query.

In one aspect of the medium, a tool of the set of tools further comprises instructions on the medium that cause the processor to retrieve a chat history of a source of the query. In one aspect of the medium, a tool of the set of tools further comprises instructions on the medium that cause the processor to execute a video analytic on a video associated with the query.

Further advantages and features consistent with this disclosure will be set forth in the following detailed description, with reference to the figures.

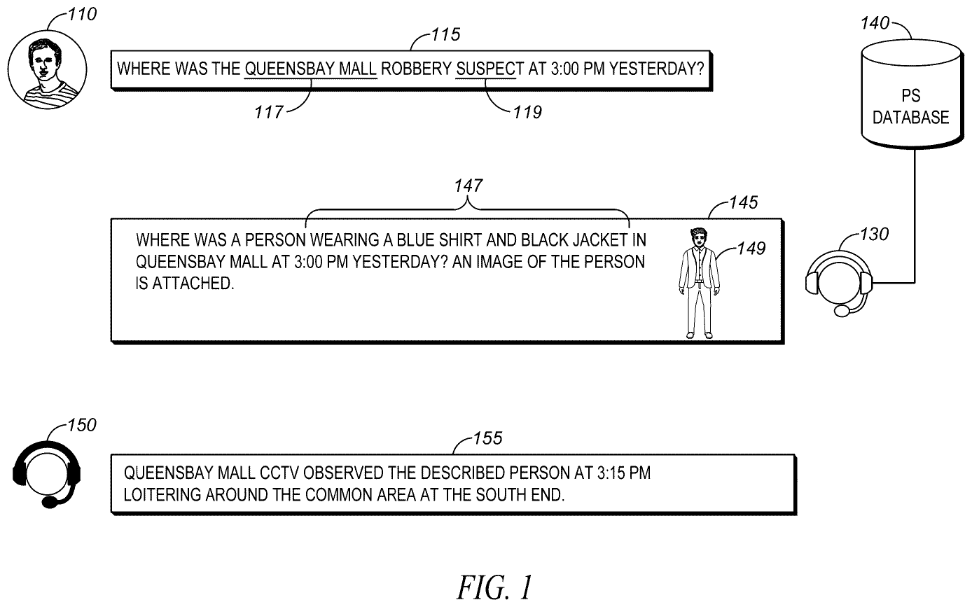

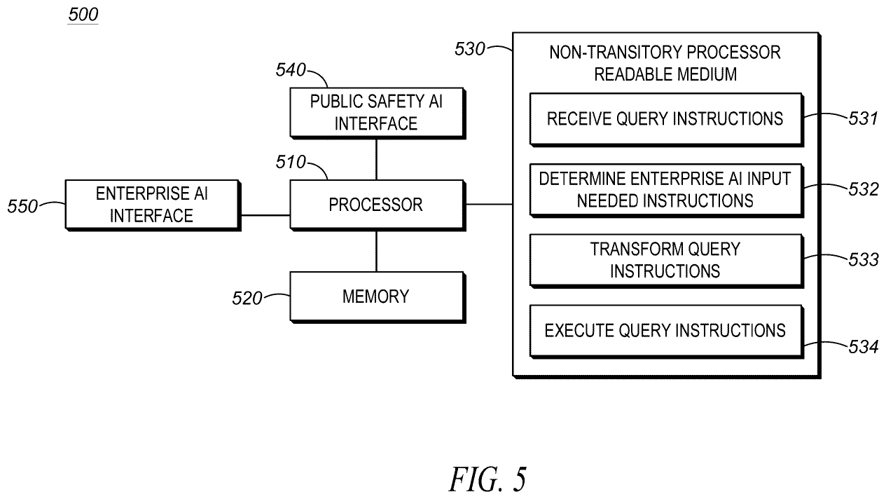

FIG. 1 is an example of an interaction 100 between a Public Safety Artificial Intelligence and an Enterprise Artificial Intelligence. FIG. 1 includes a public safety first responder 110, a device that implements the techniques described herein 130, and an enterprise artificial intelligence system 150. An example of a device that may implement the device 130 is described with respect to FIG. 5.

The public safety first responder 110 may be a person, such as a police officer, that has access to a public safety virtual assistant. As explained above, virtual assistants that are trained with domain specific knowledge are known. In this example, assume the public safety first responder is a law enforcement officer and that the public safety virtual assistant has been trained in a law enforcement context. The law enforcement officer may present a query 115 to the public safety virtual assistant. In this example, the query is, “Where was the Queensbay Mall robbery suspect at 3:00 PM yesterday?”

The device 130 may receive and analyze the query. Initially, the analysis may identify that the query includes a location 117 (e.g. Queensbay Mall) and identifies that there is an enterprise artificial intelligence system 150 associated with that location. As such, use of the enterprise artificial intelligence system may be needed to provide a correct answer to the original query 115.

The analysis of the query 115 by the device 130 can further determine that there is a term suspect 119 present in the query that may not be properly understood by the enterprise artificial intelligence system. The reason for this being the enterprise artificial intelligence system was not trained using data that would typically include the word suspect, as that is likely not normal terminology for an enterprise domain.

The device 130 may then optimize the query such that it would be better understood by the enterprise artificial intelligence system 150. For example, the device may access a public safety database 140 to replace portions of the query with portions that could be understood by the enterprise artificial intelligence system. In this example, the public safety database may include information, such as a description of what the suspect was wearing. The public safety database may also include an image of the suspect.

The enterprise artificial intelligence system 150 may know how to search its available resources for a person matching a description at a certain time. As such, the device 130 may modify the query to replace the term suspect, with the actual physical description because that is something that will be understood. In addition, the enterprise artificial intelligence system may know how to search for a person based on an image. The device may include an image of the suspect. The device creates an optimized query 145, which in this example is, “Where was a person wearing a blue shirt and black jacket in Queensbay Mall at 3:00 PM yesterday? An image of the person is attached.” As shown, the unknown term suspect has been replaced with the actual description 147 of the person which can be understood by the enterprise artificial intelligence system. Furthermore, an image 149 of the suspect that is understood by the enterprise artificial intelligence system is provided to aid the enterprise artificial intelligence system in responding to the query 145.

The enterprise artificial intelligence system 150 may then respond to the query 145. Because the query 145 has been optimized to only contain elements that are included in the enterprise context, the enterprise artificial intelligence system is able to respond to the query without requiring any type of retraining. In this example, the enterprise artificial intelligence system may respond 155 to the query with, “Queensbay Mall CCTV observed the described person at 3:15 PM loitering around the common area at the South end.” The above response assumes that the enterprise artificial intelligence system has access to the surveillance system as well as the ability to perform person searches. It should be understood that the techniques described herein are not dependent on the capabilities of the enterprise artificial intelligence system. What should be understood is that the techniques described herein transform the public safety query context into a context that can be understood in an enterprise context.

Although the above description retrieved a description and image of the suspect from a public safety database 140, it should be understood that this is not the only type of information available to transform queries. For example, the device 130 may include a list of learned public safety context and corresponding enterprise interpretation. In the present example, the list could include that suspect in the public safety context means description and image in the enterprise context, and that suspect should be replaced with description and an image.

The device 130 may compare the received query and compare terminology to the interpretation in the enterprise context. The query may then be optimized such that the query is understood by the enterprise artificial intelligence system 150. Table 1 below lists some examples of a query in the public safety context, how the enterprise might interpret the un-optimized query, and how the query may be optimized for understanding by the enterprise artificial intelligence system.

TABLE 1

| | ENTERPRISE | |
|---|---|---|
| PUBLIC SAFETY | INTERPRETATION OF | OPTIMIZED |
| CONTEXT QUERY | UN-OPTIMIZED QUERY | QUERY |
| List the hot zones | List the most | List the areas where |
| | crowded areas | security alerts have |
| | | been triggered |
| Cease radio traffic | Stop traffic in | Alert security to cease |
| | the parking lot | non-essential radio |
| | | communication |
| BOLO on person | Where is the inventory | Perform an appearance |
| with blue shirt | of blue shirts | search for people |
| | located | wearing blue shirts |

In the second row of Table 1, the query from public safety is, “List the hot zones.” In a public safety context, this may be a request to list the areas where there has been a lot of criminal activity. However in the enterprise context, a hot zone may be interpreted as a crowded area, so the enterprise virtual assistant may interpret the query as “list the most crowded areas” without regard to any criminal activity occurring. The query may then be optimized to “List the areas where security alerts have been triggered.” In this way, the term “hot zone” in the public safety context is transformed to “security alerts” in the enterprise context.

As yet another example, a command, “Cease radio traffic” may be issued which means, in a public safety context, to stop all non-essential radio communications. Without modification, this may be interpreted by the enterprise artificial intelligence system as “Stop traffic in the parking lot” which is clearly not the intended action. An optimized query, “Alert security to cease non-essential radio communication” can be provided using terminology that is explicitly understood in an enterprise context.

As yet another example, a query “BOLO on person with blue shirt” in a public safety context means Be On the Lookout for a person wearing a blue shirt. However, in an enterprise context (e.g. a retail context), such a query may be interpreted as “Where is the inventory of blue shirts located” which is not the intended query. The optimized query may be “Perform an appearance search for people wearing blue shorts.” Again, what should be understood is that terminology used in a public safety context that is not understood in an enterprise context is modified to transform the query into one which will be correctly understood in the enterprise context. Such optimization of the query can overcome the bias introduced by the enterprise artificial intelligence system to provide answers more related to an enterprise context rather than the requested public safety context.

Although database 140 was described as including suspect descriptions and images, it should be understood that the database represents any sources of data that could be used to transform queries from a public safety context to an enterprise context. Other examples to add more information to the queries could include harvesting relevant information from the internet, the cloud, officer chat history, available Internet of Things devices, etc. Furthermore, it could also include enterprise interpretable content and detail.

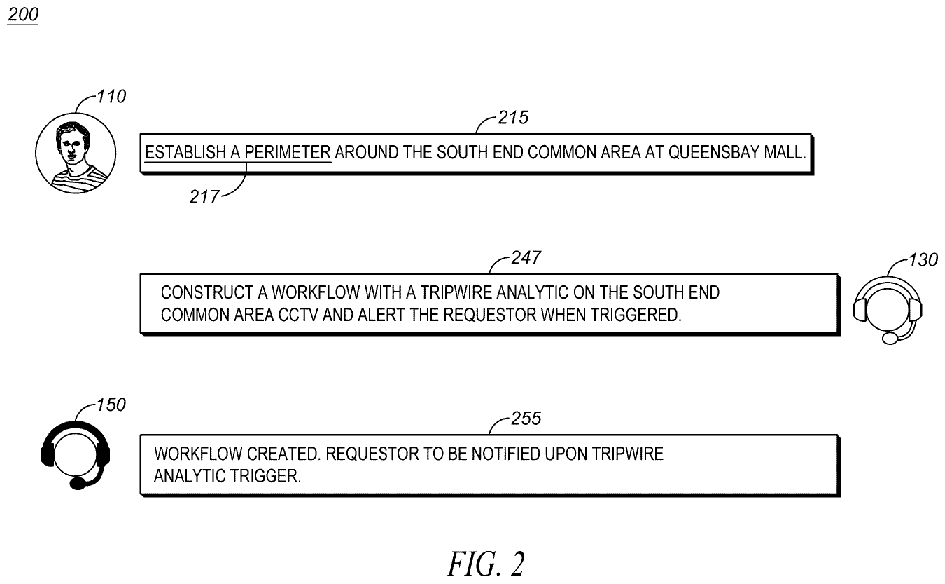

FIG. 2 is another example of an interaction 200 between a Public Safety Artificial Intelligence and an Enterprise Artificial Intelligence. FIG. 2 includes elements from those in FIG. 1 that are numbered the same. For ease of description, the description of those elements will not be repeated. FIG. 2 represents a situation where a public safety officer 110 is requesting an enterprise artificial intelligence system to perform an action. It should be understood that although the term query is used, this does not necessarily imply that the response is an immediate answer to a question.

In the example presented in FIG. 2, the query 215 is “Establish a perimeter around the South end common area at Queensbay Mall.” For example, this query may be in response to the query response 155 described with respect to FIG. 1. Once again, the device 130 may use the presence of the term “Queensbay Mall” in the query to indicate that input from the enterprise artificial intelligence system 150 associated with Queensbay Mall is needed.

The term “establish a perimeter” 217 in the query 215 may mean, in a public safety context, to set up a boundary around a certain area and provide a notification when the boundary is traversed by any individual. However, the term “establish a perimeter” may have no direct correlation to a term in the enterprise context. However, there may be functionality that provides the desired end result. In this example, the enterprise artificial intelligence system may be able to establish workflows. Workflows are a set of steps to be executed in response to certain triggers.

The enterprise artificial intelligence system 150 may also provide certain functionality that is equivalent to functionality in the public safety context, but is referred to with completely different terminology. In the present example, the enterprise artificial intelligence system may provide a tripwire analytic, which is drawing a virtual line within the field of view of a CCTV camera. If an object crosses that virtual line, an alert can be raised. The workflow can determine what action is taken when the alert is raised.

In the present example, the device 130 transforms the query 215 into the optimized query 247 which states, “Construct a workflow with a tripwire analytic on the South end common area CCTV and alert the requestor when triggered.” As should be understood, this query will have the same effect as the original query 215, in that when an object crosses the perimeter of the South end common area at Queensbay Mall, an alert will be sent to the officer 110. The response to the query 255 can indicate that the query was understood.

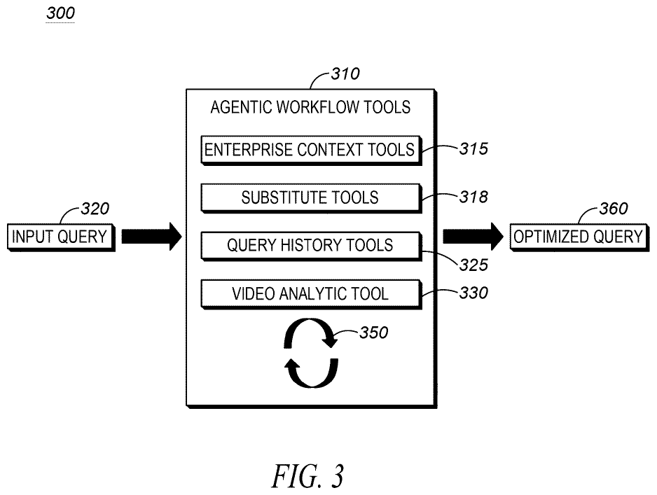

FIG. 3 is an example of the use of agentic workflows 300 to enable the interaction between a Public Safety Artificial Intelligence and an Enterprise Artificial Intelligence. In an agentic workflow, artificial intelligence agents perform tasks that do not require human supervision. An agentic workflow may provide a set of tools that can be used to execute specific tasks. A subset of those tools may be selected to transform queries including terms known in the public safety context to those known in the enterprise context. For example, there could be an agent that is a tool that when presented with the term “suspect” knows to gather description information and available images. That gathered information is then be substituted into the original query. An example of the output of such an agent was shown with respect to FIG. 1. FIG. 2 is an example of an agent that transforms a query including a command into a corresponding workflow.

Example agents can include enterprise context tools 315, where a public safety specific context on a query is determined and an enterprise context associated with the public safety context is determined. The enterprise context can be substituted for the public safety context. Another example agent can be a substitute tools 318. The substitute tools may simply convert terms in the public safety context to corresponding terms in the enterprise context.

Yet another tool, query history tools 325 may also be used. Query history tools may include tools that analyze the results of previous queries in order to convert a current query with a public safety context to an optimized query in an enterprise context. Another tool may be video analytics tools 330. The video analytics tools may cause terms in the public safety context to be converted to available video analytics. For example, changing setting up a perimeter to deploying a tripwire video analytic.

In operation, an input query 320 may be received by a device that is implementing the techniques described herein. Using an agentic workflow 310, the device may analyze the query to identify tools needed to convert the query from a public safety context to an enterprise context. This process may repeat 350 until all terms in the input query that have a public safety context are converted to terms that are understandable by the enterprise artificial intelligence system or there are no more tools available to perform such conversion. At that point, an optimized query 360 is generated. The optimized query can then be executed by the enterprise artificial intelligence system, as described above.

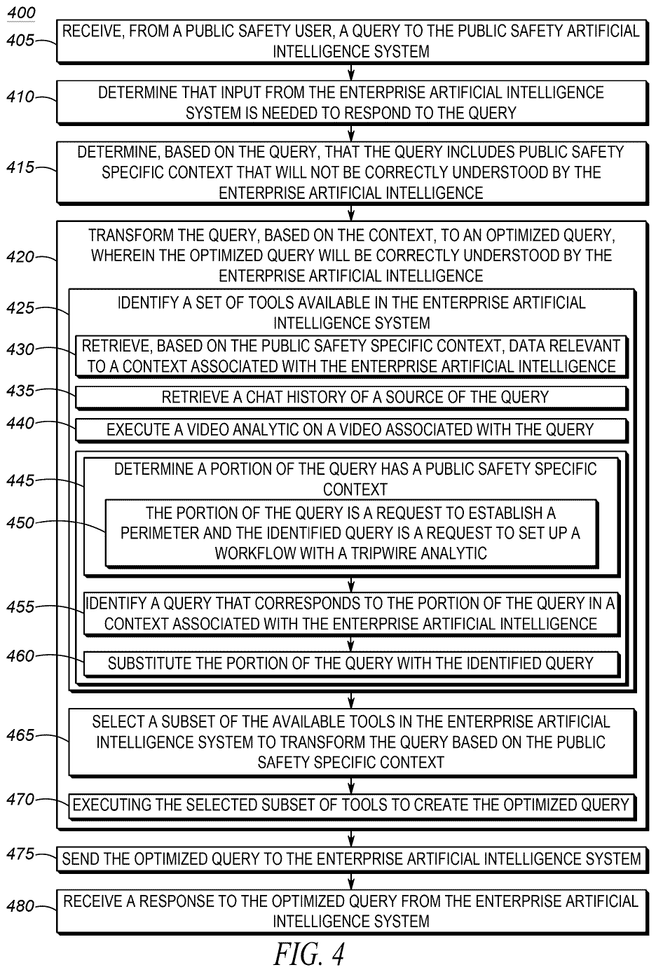

FIG. 4 is an example of a flow diagram 400 that implements the querying an enterprise artificial intelligence system techniques described herein. In block 405, a query to the public safety artificial intelligence system is received from a public safety user. For example, the user may be involved in a public safety incident and utilizes a public safety virtual assistant to ask a question that may aid in resolving the public safety incident. As it is a public safety user initiating the query, the context of the query will generally be a public safety context.

In block 410, it is determined that input from the enterprise artificial intelligence system is needed to respond to the query. For example, the query may ask for information that is not available from the public safety artificial intelligence system. For example there may be enterprise related sensors (e.g. video cameras, IoT sensors, building sensors, databases, etc.) that are not accessible to the public safety artificial intelligence system and thus those resources cannot be used in answering the query. However, the resources are available to the enterprise artificial intelligence system, which may be helpful in responding to the query.

In block 415, it is determined, based on the query, that the query includes public safety specific context that will not be correctly understood by the enterprise artificial intelligence. For example, the query may use terminology that exists in the public safety context but is different than the terminology used in the enterprise context. The query may use terminology that exists in the public safety context, but does not exist in the enterprise context. What should be understood is that the query, as received, includes portions that although understandable in a public safety context would not be understood by an enterprise artificial intelligence operating in an enterprise context.

In block 420, the query is transformed, based on the context, to an optimized query, wherein the optimized query will be correctly understood by the enterprise artificial intelligence. As explained above, the public safety artificial intelligence system is designed to operate in a public safety context, while the enterprise artificial intelligence system is designed to operate in an enterprise context. A query using a public safety context may not be properly processed by an enterprise artificial intelligence system. To alleviate this problem, the query in the public safety context is transformed such that it will be understood by the enterprise artificial intelligence system.

In block 425 a set of tools available in the enterprise artificial intelligence system is identified. As explained above, in some implementation an agentic workflow is used to transform the query. An agentic workflow includes a plurality of tools that may be used to convert the query from the public safety context to the enterprise context. The initial query may be processed by each of these tools until either the entire query has been transformed or there are no more tools available that can be utilized to transform the query. For example, each available tool may be applied to the query. If the tool can aid in the transformation, it is used. If not, the system moves to the next available tool to determine if it is needed.

In block 430, data relevant to a context associated with the enterprise artificial intelligence system is retrieved based on the public safety specific context. For example, as explained above, the term “suspect” may not have meaning in the enterprise context although it does have meaning in the public safety context. The data retrieved could be data used to convert the query into the enterprise context. For example, the term suspect causes data, such as the visual description of the suspect and an image of the suspect to be retrieved. This data can then be used to transform the query. This is an example of a tool that may be utilized in the agentic workflow.

In block 435, a chat history of the source of the query is retrieved. For example, an officer's chat history may indicate he is in a certain location (e.g. Queensbay Mall, etc.). The officer may present a query, such as “where was the suspect at 3:00 PM?” without providing any further context as to the location. However, if the chat history is analyzed, it can be determined where the officer is located. Such information can be utilized to find a suitable enterprise artificial intelligence system to which the query can be sent as well as to help transform the query to a form that can be understood by the located enterprise artificial intelligence system. This is yet another example of a tool that may be utilized in the agentic workflow to transform the query.

In block 440, a video analytic is executed on a video associated with the query. For example, a video analytic may be run on data in a public safety database context to extract features that are relevant to the enterprise context. As described above, the term “suspect” may not have meaning in an enterprise context. However a visual description and an image of a suspect may be understood. A video analytic may be run to extract such information from a public safety database to provide in the transformed query. This is yet another example of a tool that may be utilized in the agentic workflow to transform the query.

In block 445, a portion of the query has a public safety specific context is determined. For example, a portion of the query in the public safety context that does not have a corresponding enterprise context is determined. This particular tool is useful when the portion of the query has to be converted to terminology that may be completely different in the enterprise context.

In block 450, the portion of the query is a request to establish a perimeter and the identified query is a request to set up a workflow with a tripwire analytic. This is a specific example of utilizing this tool when the query requests that a perimeter be set up, but the enterprise artificial intelligence system has no concept of a perimeter, but does have a concept of a tripwire analytic being set up on a camera field of view.

In block 455, a query that corresponds to the portion of the query in a context associated with the enterprise artificial intelligence is identified. In the present example, the request to set up a perimeter could be achieved by creating a new workflow whose objective is to produce the results requested in the original query. In the present example, the original request was to set up a perimeter which, in a public safety context means to observe persons entering/exiting a defined area. This can be achieved by the enterprise artificial intelligence by setting up a workflow that monitors a tripwire video analytic. What should be understood is that it is determined what combination of capabilities in the enterprise artificial intelligence system can be used to satisfy the original query.

In block 460, the portion of the query is substituted with the identified query. In other words the portion of the query that cannot be directly translated to a query in the enterprise context is substituted with a portion that can. In the present example, “set a perimeter” in the query may not have an equivalent in the enterprise context. However, “create a workflow with a tripwire video analytic” may achieve the same results. As such, “set a perimeter” may be substituted with the instruction to create a workflow with a tripwire analytic.

In block 465, a subset of the available tools in the enterprise artificial intelligence system is selected to transform the query based on the public safety specific context. As explained above, in an agentic workflow, a set of tools is provided to transform queries from a public safety context to an enterprise context. Examples of such tools were provided with respect to the contents of block 425. Each tool may not be necessary for the transformation of each query. Thus, in block 465 only those tools that are needed to transform the query are selected.

In block 470, the selected subset of tools is executed to create the optimized query. In other words, the tools that are needed to transform the query from a public safety context to an enterprise context are applied to the originally received query. Once executed, these tools will convert the originally received query that is understandable in the public safety context to an optimized query that is understandable by an enterprise artificial intelligence system in an enterprise context.

In block 475, the optimized query is sent to the enterprise artificial intelligence system. Since the original query has been optimized for execution by the enterprise artificial intelligence system, the query can be sent to the enterprise artificial intelligence system. From the perspective of the enterprise artificial intelligence system, it appears as if it were receiving a query directly from an enterprise user, as opposed to a query that was originally generated in a public safety context and then transformed into an enterprise context query.

In block 480, a response to the optimized query is received from the enterprise artificial intelligence system. The enterprise artificial intelligence system may run the query and return a response. The response may then be sent to the user that originated the query from the public safety artificial intelligence system.

FIG. 5 is an example of a hardware device 500 that implements the querying an enterprise artificial intelligence system techniques described herein. It should be understood that FIG. 5 represents one example implementation of a computing device that utilizes the techniques described herein. Although only a single processor is shown, it would be readily understood that a person of skill in the art would recognize that distributed implementations are also possible. For example, the various pieces of functionality described above (e.g. receiving queries, transforming queries, etc.) could be implemented on multiple devices that are communicatively coupled. FIG. 5 is not intended to imply that all the functionality described above must be implemented on a single device.

Device 500 may include processor 510, memory 520, non-transitory processor readable medium 530, public safety artificial intelligence interface 540, and enterprise artificial intelligence interface 550.

Processor 510 may be coupled to memory 520. Memory 520 may store a set of instructions that when executed by processor 510 cause processor 510 to implement the techniques described herein. Processor 510 may cause memory 520 to load a set of processor executable instructions from non-transitory processor readable medium 530. Non-transitory processor readable medium 530 may contain a set of instructions thereon that when executed by processor 510 cause the processor to implement the various techniques described herein.

For example, medium 530 may include receive query instructions 531. The receive query instructions 531 may cause the processor to receive a query directed to a public safety artificial intelligence. For example, the query could be received via the public safety artificial intelligence interface 540. The receive query instructions 531 are described throughout this description generally, including places such as the description of block 405.

The medium 530 may include determine enterprise artificial intelligence input needed instructions 532. The determine enterprise artificial intelligence input needed instructions 532 may cause the processor to determine that input to the query will require input from an enterprise artificial intelligence and that the received query includes items that will not be understood by the enterprise artificial intelligence. The determine enterprise artificial intelligence input needed instructions 532 are described throughout this description generally, including places such as the description of blocks 410 and 415.

The medium 530 may include transform query instructions 533. The transform query instructions 533 may cause the processor to determine the portions of the received query that will not be understood by the enterprise artificial intelligence and cause those portions of the query to be transformed such that the enterprise artificial intelligence can understand those portions. The transform query instructions 533 are described throughout this description generally, including places such as the description of blocks 420-470.

The medium 530 may include execute query instructions 534. The execute query instructions 534 may cause the processor to send the transformed query to the enterprise artificial intelligence system for execution. For example, the transformed query may be sent to the enterprise artificial intelligence system via the enterprise artificial intelligence interface 550. The query response may then be sent to the original public safety query requestor. For example, the response could be sent via the public safety artificial intelligence interface 540. The execute query instructions 534 are described throughout this description generally, including places such as the description of blocks 475 and 480.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot receive a query from a public safety user using a public safety artificial intelligence, and using an agentic workflow, convert the query into a context understandable by an enterprise artificial intelligence, and then process the converted query using the enterprise artificial intelligence system, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network

(WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method of querying an enterprise artificial intelligence system based on a context from a public safety artificial intelligence system comprising:
receiving, from a public safety user, a query to the public safety artificial intelligence system;
determining that input from the enterprise artificial intelligence system is needed to respond to the query;
determining, based on the query, that the query includes public safety specific context that will not be correctly understood by the enterprise artificial intelligence;
transforming the query, based on the context, to an optimized query, wherein the optimized query will be correctly understood by the enterprise artificial intelligence;
sending the optimized query to the enterprise artificial intelligence system; and
receiving a response to the optimized query from the enterprise artificial intelligence system.

2. The method of claim 1 wherein transforming the query further comprises:
identifying a set of tools available in the enterprise artificial intelligence system;
selecting a subset of the available tools in the enterprise artificial intelligence system to transform the query based on the public safety specific context; and
executing the selected subset of tools to create the optimized query.

3. The method of claim 2 wherein a tool of the set of tools further comprises:
retrieving, based on the public safety specific context, data relevant to a context associated with the enterprise artificial intelligence.

4. The method of claim 2 wherein a tool of the set of tools further comprises:
determining a portion of the query has a public safety specific context;
identifying a query that corresponds to the portion of the query in a context associated with the enterprise artificial intelligence; and
substituting the portion of the query with the identified query.

5. The method of claim 4 wherein the portion of the query is a request to establish a perimeter and the identified query is a request to set up a workflow with a tripwire analytic.

6. The method of claim 2 wherein a tool of the set of tools further comprises:
retrieving a chat history of a source of the query.

7. The method of claim 2 wherein a tool of the set of tools further comprises:
executing a video analytic on a video associated with the query.

8. A system for querying an enterprise artificial intelligence system based on a context from a public safety artificial intelligence system comprising:
a processor; and
a memory coupled to the processor, the memory containing a set of instructions thereon that when executed by the processor cause the processor to:
receive, from a public safety user, a query to the public safety artificial intelligence system;
determine that input from the enterprise artificial intelligence system is needed to respond to the query;
determine, based on the query, that the query includes public safety specific context that will not be correctly understood by the enterprise artificial intelligence;
transform the query, based on the context, to an optimized query, wherein the optimized query will be correctly understood by the enterprise artificial intelligence;
send the optimized query to the enterprise artificial intelligence system; and
receive a response to the optimized query from the enterprise artificial intelligence system.

9. The system of claim 8 wherein transforming the query further comprises instructions on the memory that cause the processor to:
identify a set of tools available in the enterprise artificial intelligence system;
select a subset of the available tools in the enterprise artificial intelligence system to transform the query based on the public safety specific context; and
execute the selected subset of tools to create the optimized query.

10. The system of claim 9 wherein a tool of the set of tools further comprises instructions on the memory that cause the processor to:
retrieve, based on the public safety specific context, data relevant to a context associated with the enterprise artificial intelligence.

11. The system of claim 9 wherein a tool of the set of tools further comprises instructions on the memory that cause the processor to:
determine a portion of the query has a public safety specific context;
identify a query that corresponds to the portion of the query in a context associated with the enterprise artificial intelligence; and
substitute the portion of the query with the identified query.

12. The system of claim 11 wherein the portion of the query is a request to establish a perimeter and the identified query is a request to set up a workflow with a tripwire analytic.

13. The system of claim 9 wherein a tool of the set of tools further comprises instructions on the memory that cause the processor to:
retrieve a chat history of a source of the query.

14. The system of claim 9 wherein a tool of the set of tools further comprises instructions on the memory that cause the processor to:
execute a video analytic on a video associated with the query.

15. A non-transitory processor readable medium containing a set of instructions thereon for querying an enterprise artificial intelligence system based on a context from a public safety artificial intelligence system that when executed by a processor cause the processor to:
receive, from a public safety user, a query to the public safety artificial intelligence system;
determine that input from the enterprise artificial intelligence system is needed to respond to the query;
determine, based on the query, that the query includes public safety specific context that will not be correctly understood by the enterprise artificial intelligence;
transform the query, based on the context, to an optimized query, wherein the optimized query will be correctly understood by the enterprise artificial intelligence;
send the optimized query to the enterprise artificial intelligence system; and
receive a response to the optimized query from the enterprise artificial intelligence system.

16. The medium of claim 15 wherein transforming the query further comprises instructions on the medium that cause the processor to:
identify a set of tools available in the enterprise artificial intelligence system;
select a subset of the available tools in the enterprise artificial intelligence system to transform the query based on the public safety specific context; and
execute the selected subset of tools to create the optimized query.

17. The medium of claim 16 wherein a tool of the set of tools further comprises instructions on the medium that cause the processor to:
retrieve, based on the public safety specific context, data relevant to a context associated with the enterprise artificial intelligence.

18. The medium of claim 16 wherein a tool of the set of tools further comprises instructions on the medium that cause the processor to:
determine a portion of the query has a public safety specific context;
identify a query that corresponds to the portion of the query in a context associated with the enterprise artificial intelligence; and
substitute the portion of the query with the identified query.

19. The medium of claim 16 wherein a tool of the set of tools further comprises instructions on the medium that cause the processor to:
retrieve a chat history of a source of the query.

20. The medium of claim 16 wherein a tool of the set of tools further comprises instructions on the medium that cause the processor to:
execute a video analytic on a video associated with the query.
